(19) United States
(12) Patent Application Publication
(10) Pub. No.: US 2003/0209695 A1
(43) Pub. Date: Nov. 13, 2003

(54) Dispersant composition

(76) Inventors: Toshitaka Tsuzuki, Osaka (JP); Akitaka Miyata, Osaka (JP); Shiho Naruse, Osaka (JP)

Correspondence Address: Thomas F Roland, National Starch and Chemical, 10 Fiderne Avenue, Bridgewater, NJ, 08807-3300, US

(21) Appl. No.: 10/182,474

(22) PCT Filed: Jan. 31, 2001
(86) PCT No.: PCT/US01/03058

(30) Foreign Application Priority Data
Feb. 9, 2000 (JP) 2000-031864

(51) Int. Cl. B01F 3/00; C09K 3/00

(52) U.S. Cl. 252/363.5

(57) ABSTRACT

A dispersant composition for inorganic substances, used in the presence of an aqueous solvent, is characterized by containing a polymer containing polyalkylene oxide groups, anionic and cationic groups, the polyalkylene oxide group being represented by formula (I): —(R¹—O)n-R² [in formula (I), R¹ represents an ethylene group or a propylene group, R² represents an alkyl group having carbon atoms of 1 to 20, which may contain hydrogen or a substitute group, and n is an integer in the range of 1 to 300]. The anionic group is preferably selected from the group consisting of a carboxyl group, sulfonic acid group, phosphoric acid group, carboxylate group, sulfonate group and phosphate group. The cationic group is preferably selected from the group consisting of an amino group and an ammonium base. Thus, the dispersant composition for inorganic substances makes it possible to improve at least one of the dispersing property and dispersing stability of the inorganic substance in water.

### BACKGROUND OF THE INVENTION

1. Field of the Invention

The present invention is intended to provide a novel dispersant composition for dispersing an inorganic substance in water, and particularly concerns a novel dispersant composition for an inorganic substance, which makes it possible for an inorganic pigment, such as titanium dioxide, calcium carbonate and clay, and a hydraulic material, such as calcined calcium sulfate and cement, to have improved dispersing property and dispersing stability to water.

2. Description of the Related Art

Conventionally, various dispersant compositions for inorganic substances have been developed and proposed in order for the inorganic substance to have improved dispersing property and dispersing stability to water and also to have improved processability and other characteristics. Here, the inorganic substance, for example, includes an inorganic pigment such as titanium dioxide, calcium carbonate and clay and a hydraulic material such as calcined calcium sulfate and cement.

With respect to such a dispersant composition for inorganic substances, a dispersant composition containing carboxylic acid and/or carboxylate has been proposed (see JP No. 38095/1978 (Tokukoushou 53-38095), and JP No. 19643/1988 (Tokukoushou 63-19643)). In this dispersant composition, particles of an inorganic substance are dispersed in water effectively in the following manner. First, one portion of carboxyl groups of the dispersant composition is allowed to adhere to the surface of each particle of the inorganic substance. The carboxyl group has a negative ionic property, and is negatively charged. Therefore, since other carboxyl groups which have not contributed to the adhesion are electrically repulsive from each other so that the particles of the inorganic substance are dispersed in water.

However, a problem with this dispersant composition is that when it is applied to a hydraulic material which is one type of inorganic substances, the setting time of the hydraulic material tends to becomes longer.

“The setting time of the hydraulic material becomes longer” means that the setting of the hydraulic material, exerted by a reaction with water, becomes longer due to the addition of the dispersant composition.

The reason for the prolonged setting time of the hydraulic material is explained as follows: Since the adhesion between the carboxyl group and the particle of the inorganic material is strong so that the adhesion of the carboxyl group to the surface of the inorganic particle intervenes with the reaction between the particles of the inorganic substance and water; thus, the setting of the hydraulic material caused by a hydration reaction of the particles of the inorganic substance is delayed, with the result that the setting time of the hydraulic material becomes longer.

Consequently, there have been demands for an improved dispersant composition for inorganic substances, which have superior dispersing property and dispersing stability to particles of the inorganic substance with less adverse effects to other properties of the inorganic substance to be dispersed.

In the present specification, “the dispersing property of the inorganic substance” refers to a characteristic in which an inorganic substance is uniformly suspended in a medium in a liquid phase without generating coagulation, and the characteristic of the dispersant composition for improving the dispersing property of the inorganic substance is also referred to as “the dispersing property of the dispersant composition.” Moreover, “the dispersing stability of an inorganic substance” refers to the fact that the dispersing property of the inorganic substance is hardly reduced even after a long period of time by adding dispersant composition, and the characteristic of the dispersant composition for improving the dispersing stability of the inorganic substance is also referred to as “the dispersing stability of the dispersant composition.”

Various studies have been made on solutions to the problems with the above-mentioned dispersant composition containing carboxylic acid and/or carboxylate (see JP No. 38380/1983 (Tokukoushou 58-38380), JP No. 18338/1984 (Tokukoushou 59-18338), JP No. 285140/1988 (Tokukaishou 63-285140), JP No. 216140/1993 (Tokukaihei 5-216140), JP No. 86990/1997 (Tokukaihei 9-86990) and JP No. 268041/1997 (Tokukaihei 9-268041).

JP No. 38380/1983 (Tokukoushou 58-38380) discloses a dispersant composition in which a copolymer obtained from polyethylene oxide monoallyl ether and a maleic acid-based monomer is used as a main component of the dispersant composition for hydraulic materials. JP No. 18338/1984 (Tokukoushou 59-18338) discloses a dispersant composition in which a copolymer, obtained from polyalkylene oxide mono(meth)acrylate, a (meth)acrylic acid-based monomer and a monomer copolymerizable with these monomers, is used as a main component of the dispersant composition for hydraulic materials.

These copolymers have a non-ionic hydrophilic group called polyalkylene oxide chain as well as an anionic hydrophilic group called carboxyl group in their molecules. It has been reported that when a dispersant composition using each of these copolymers is adopted, the dispersing property of the hydraulic material to be dispersed is improved with less susceptibility to a prolonged setting time of the hydraulic material, as compared with the above-mentioned dispersant composition containing carboxylic acid and/or carboxylate.

However, in recent years, there have been demands for further improvements in the dispersing property of inorganic substances, and for dispersant compositions for inorganic substances, which are superior in improving the dispersing property and dispersing stability of inorganic materials, give less adverse effects on the other properties, and are usable in water or in a mixture of water and another water-soluble solvent.

The present invention has been devised to solve the above-mentioned problems, and its objective is to provide a novel dispersant composition for an inorganic substance, which is used for dispersing the inorganic substance in water, which makes it possible for an inorganic pigment, such as titanium dioxide, calcium carbonate and clay, and a hydraulic material, such as calcined calcium sulfate and cement, to improve at least one of the dispersing property and dispersing stability to water, and which can alleviate or virtually solve the problem of giving adverse effects on the other properties.

### SUMMARY OF THE INVENTION

As a result of various researches on dispersant compositions for inorganic substances, the inventors of the present invention have found that, as will be described later in detail, a dispersant composition, which contains a polymer containing polyalkylene oxide groups, and also containing anionic groups as well as cationic groups, can solve the above-mentioned problems, and have completed the present invention.

Normally, a particle of an inorganic substance has a charge on its surface. It is considered that the charge on the surface of the particle is either a positive charge, a negative charge, or zero, from the viewpoint of the particle as a whole. However, taking into consideration charges at respective parts of the surface with respect to the actual surface of the particle, it is considered that positive and negative charges are located in a mixed manner. Therefore, the sum of these charges are supposed to form a charge of the particle as a whole, and the distribution of charges on the surface of the particle assumes a very complex state.

In order to allow a polymer to adhere to the surface of an inorganic substance having such a complex charge distribution, it is preferable to provide it with both cationic and anionic groups at the same time. Moreover, it is also important that the ratio of the number of cationic groups and the number of anionic groups can be easily changed. Therefore, the polymer, which is a component of the dispersant composition, needs to possess cationic and anionic groups at the same time, and the ratio of these numbers (the number of cationic groups/the number of anionic groups) needs to be readily changed in accordance with the conditions of the surface of particles of the inorganic substance.

Moreover, only allowing a polymer to adhere to particles of an inorganic substance might cause adverse effects on the other properties, even if the dispersing property and dispersing stability are improved. The inventors of the present invention have focused their attention on a polyalkylene oxide group as a functional group for alleviating such adverse effects, and have further made research efforts.

As a result, the inventors have found that a dispersant composition which contains a polymer having, as its main component, three kinds of functional groups, that is, polyalkylene oxide groups, anionic groups and cationic groups, exerts superior effects, and have completed the present invention.

One embodiment of the present invention provides a novel dispersant composition for inorganic substances, which is used in the presence of an aqueous solvent, and contains a polymer containing polyalkylene oxide groups, the polyalkylene oxide group being represented by formula (I):

—(R¹—O)_{n—R}² (I)

[in formula (I),

R¹ represents an ethylene group or a propylene group,

R² represents an alkyl group having carbon atoms of 1 to 20, which may contain hydrogen or a substitute group, and

n is an integer in the range of 1 to 300],

wherein polymer containing polyalkylene oxide groups further contains anionic groups and cationic groups.

In particular, the dispersant composition of the present invention is preferably used as a dispersant composition for an inorganic substance in water, such as an inorganic pigment such as titanium oxide, calcium carbonate and clay, and a hydraulic material such as calcined calcium sulfate and cement.

In the present specification, “the aqueous solvent” may be so-called water such as ion exchange water, distilled water and pure water, and “the aqueous solvent” also includes water appropriately having a water-soluble solvent (for example, acetone and lower alcohol, etc.); however, water is more preferable.

Embodiments of the Invention

The “polymer containing polyalkylene oxide groups” of the present invention refers to a main component of a dispersant composition, which imparts to the dispersant composition a function for improving the dispersing property of an inorganic substance.

Here, “the polyalkylene oxide group” refers to a functional group represented by formula (I):

—(R¹—O)ₙ-R² (I)

[in formula (I),

R¹ represents an ethylene group or a propylene group,

R² represents an alkyl group having carbon atoms of 1 to 20, which may contain hydrogen or a substitute group, and

n is an integer in the range of 1 to 300].

In this case, “the ethylene group or propylene group” represented by R¹ specifically refers to —CH₂CH₂—, —CH(CH₃)—CH₂—, or —CH₂CH₂CH₂—, and in particular, the ethylene group (—CH₂CH₂—) is preferably used.

With respect to “the alkyl group having carbon atoms of 1 to 20, which may contain hydrogen or a substitute group” represented by R, examples thereof include hydrogen, a methyl group, an ethyl group, a dodecyl group and an octadecyl group, and a methyl group is preferably used.

Here, n is an integer in the range of 1 to 300, more preferably, 5 to 100, and most preferably, 8 to 50.

“The polymer containing polyalkylene oxide groups” can also contain the above-mentioned polyalkylene oxide group alone or in combination thereof.

Furthermore, “the anionic group” of the present invention refers to a functional group having a negative charge (for example, —COO—, —SO₃—, etc.) (including a functional group whose negative charge is electrically neutralized by a paired cation (for example, —COO—Na⁺, —SO₃—K⁺, etc.)) and a functional group capable of forming a functional group having a negative charge by releasing a hydrogen ion in water (for example, —COOH, —SO₃H, etc.). Here, with respect to “the functional group having a negative charge” and “the functional group capable of forming a functional group having a negative charge by releasing a hydrogen ion in water”, it is taken for granted that they are respectively exchangeable easily, for example, by changing the ambient conditions of the respective functional groups, such as pH and concentration. With respect to “the anionic groups” of the present invention, these functional groups may be used alone or in combination thereof in accordance with the properties of the dispersant composition to be obtained.

Here, with respect to “the functional group having a negative charge (including a functional group whose negative charge is electrically neutralized by a paired cation)”, examples thereof include: carboxylate groups (—COO— and —COOM¹), sulfonate groups (—SO₃⁻ and SO₃M²), and phosphate groups (—PO₄H⁻, —PO₄²⁻, and —PO₄M³M⁴) [in which M¹, M², M³ and M⁴ are alkali metal, alkali earth metal or ammonium. (Here, either of M³ and M⁴ may be hydrogen)].

Moreover, with respect to “the functional group capable of forming a functional group having a negative charge by releasing a hydrogen ion in water”, examples thereof include: a carboxyl group (—COOH), a sulfonic acid group (—SO₃H) and a phosphoric acid group (—PO₄H₂).

In “the polymer containing polyalkylene oxide groups” in accordance with the present invention, its anionic group is at least one member preferably selected from the group consisting of a carboxyl group, a sulfonic acid group, a phosphoric acid group, a carboxylate group, a sulfonate group and a phosphate group.

Here, the polymer containing polyalkylene oxide groups may contain an anionic group alone or in combination thereof.

Furthermore, “the cationic group” of the present invention refers to a functional group having a positive charge (for example, —N⁺(CH₃)₃ and —C₆H₄N⁺—CH₃)(including a functional group that is electrically neutralized by a paired anion (for example, —N⁺(CH₃)₃Cl⁻ and —C₆H₄N⁺—CH₃Br—, etc.)), and includes a functional group capable of forming a functional group having a positive charge by receiving a hydrogen ion in water (for example, —N(CH₃)₂ and —C₆H₄N). With respect to “the functional group having a positive charge” and “the functional group capable of forming a functional group having a positive charge by receiving a hydrogen ion in water”, it is taken for granted that they are respectively exchangeable easily, for example, by changing the ambient conditions of the respective functional groups, such as pH and concentration. With respect to “the cationic group” of the present invention, these functional groups may be used alone or in combination thereof in accordance with the properties of the dispersant composition to be obtained.

With respect to “the functional group having a positive charge”, examples thereof include an ammonium base

([—NR³R⁴R⁵]⁺ and [—NR³R⁴R⁵]⁺X⁻) and a pyridinium base ([—C₅H₄N—R⁶]⁺ and [—C₅H₄N—R⁶]⁺X⁻), [in which R³, R⁴, R⁵ and R⁶ represent a hydrogen atom, a methyl group, an ethyl group, a benzyl group, a phenyl group or a methylphenyl group, and X⁻ is a halogen ion such as a chlorine ion and a bromine ion, an acetic acid ion [CH₃COO⁻], a methylsulfate ion [CH₃SO₄⁻], an ethylsulfate ion [C₂H₅SO₄⁻], a p-toluenesulfonate ion [CH₃C₆H₄SO₃⁻], etc.

Moreover, with respect to “the functional group capable of forming a functional group having a positive charge by receiving a hydrogen ion in water”, examples thereof include an amino group (—N R⁷R⁸) [in which R⁷ and R⁸ represent a hydrogen atom, a methyl group, an ethyl group, a benzyl group, a phenyl group or a methylphenyl group] and a pyridyl group (—C₆H₄N).

With respect to “the polymer containing polyalkylene oxide groups”, it is preferable that its cationic group is at least one member selected from the group consisting of an amino group and an ammonium base.

Moreover, with respect to the cationic group, a tertiary amino group and a quaternary ammonium base are preferably used. In other words, it is preferable that none of R³, R⁴, R⁵ and R⁶ are hydrogen atoms, and they are preferably selected from a methyl group, an ethyl group, a benzyl group, a phenyl group and a methylphenyl group.

Furthermore, “the polymer containing polyalkylene oxide groups” may contain a cationic group alone or in combination thereof.

The physical properties of “the polymer containing polyalkylene oxide groups” may be appropriately selected depending on the properties of the dispersant composition for inorganic substances to be obtained; and the weight average molecular weight thereof is preferably set in the range of 1,000 to 200,000, more preferably, 5,000 to 50,000, and most preferably, 8,000 to 40,000.

Moreover, “the polymer containing polyalkylene oxide groups” has its ratio of the number of anionic groups and that of cationic groups (anionic groups/cationic groups) set in the range of 30/70 to 99.5/0.5, more preferably, 50/50 to 99.5/0.5, and most preferably, 80/20 to 99/1.

Furthermore, “the polymer containing polyalkylene oxide groups” has its ratio of the number of polyalkylene oxide groups and the sum of the numbers of cationic groups and anionic groups (the number of polyalkylene oxide group/(the number of cationic groups+the number of anionic groups)), is preferably set in the range of 10/90 to 50/50, more preferably, 15/85 to 45/55, and most preferably, 20/80 to 40/60.

Each of the above-mentioned polyalkylene oxide group, anionic group and cationic group is preferably given as a side chain of “the polymer containing polyalkylene oxide groups”.

With respect to “the polymer containing polyalkylene oxide groups”, the ratio of the number of anionic groups and the number of cationic groups, as well as the ratio of the number of polyalkylene oxide groups and the sum of the numbers of cationic groups and anionic groups, is in general virtually the same as a value calculated based upon the number of anionic groups, the number of cationic groups and the number of polyalkylene oxide groups that are contained in a mixture of monomers used for preparing a polymer containing polyalkylene oxide groups, as will be described later.

“The polymer containing polyalkylene oxide groups” is obtained by polymerizing a monomer mixture consisting of:

(A) a monomer having an anionic group and a double bond between carbon atoms;

(B) a monomer having a cationic group and a double bond between carbon atoms; and

(C) a monomer having a polyalkylene oxide group and a double bond between carbon atoms,

wherein the polyalkylene oxide group is represented by formula (I):

—(R¹—O)ₙ-R² (I)

[in formula (I),

R¹ represents an ethylene group or a propylene group,

R² represents an alkyl group having carbon atoms of 1 to 20, which may contain hydrogen or a substitute group, and

n is an integer in the range of 1 to 300].

“(A) a monomer having an anionic group and a double bond between carbons (hereinafter, referred to as “monomer (A)”)” refers to a monomer which supplies an anionic group to a polymer containing polyalkylene oxide groups through a polymerization reaction (addition polymerization or radical polymerization).

“Anionic group” refers to the above-mentioned anionic group, which includes “a functional group having a negative charge (including a functional group that is electrically neutralized by a paired cation)” and “a functional group capable of forming a functional group having a negative charge by releasing a hydrogen ion in water”. Therefore, with respect to the anionic group, examples thereof include a carboxyl group, a sulfonic acid group, a phosphoric acid group, a carboxylate group, a sulfonate group and phosphate group. The carboxyl group contained in monomer (A) also includes a carboxylic anhydride.

Moreover, “double bond between carbon atoms” refers to a functional group that enables a polymerization reaction (an addition polymerization or a radical polymerization), and examples thereof include an ethylene-type double bond between carbon atoms, such as a vinyl group (CH₂═CH—), a (meth)allyl group (CH₂═CH—CH₂— and CH₂═C(CH₃)—CH₂—), a (meth)acryloyloxy group (CH₂═CH—COO— and CH₂═C(CH₃)—COO—) and —COO—CH═CH—COO—.

In the present specification, acrylic acid and methacrylic acid are collectively referred to as “(meth)acrylic acid”; acrylic acid ester and methacrylic acid ester are collectively referred to as “(meth)acrylic acid ester” or “(meth)acrylate”. The same is true for allyl group and acryloyloxy group.

Therefore, monomer (A) have take any of the combinations of the above-mentioned anionic groups and double bonds between carbon atoms, as long as it does not give any adverse effect on the properties of the resulting “polymer containing polyalkylene oxide groups”, and it is not intended to be limited by the number of anionic groups contained therein and the number of double bonds between carbon atoms.

Monomer (A) preferably contains as an anionic group at least one member selected from the group consisting of a carboxyl group, a sulfonic acid group, a phosphoric acid group, a carboxylate group, a sulfonate group and a phosphate group.

With respect to monomer (A) containing at least one member selected from a carboxyl group and a carboxylate group, examples thereof include compounds that contain at least one member selected from a carboxyl group and a carboxylate group and that has a double bond between carbon atoms, such as:

(meth)acrylic acid, maleic acid (including maleic anhydride), itaconic acid (including itaconic anhydride), crotonic acid, 2-(meth)acryloyloxyethyl succinic acid [CH₂═C(CH₃)COOCH₂CH₂OCOCH₂CH₂COOH] and [CH₂═CHCOOCH₂CH₂OCOCH₂CH₂COOH], 2-(meth)acryloyloxyethyl phthalic acid [CH₂═C(CH₃)COOCH₂CH₂OCOC₆H₄COOH] and [CH₂═CHCOOCH₂CH₂OCOC₆H₄COOH], 2-(meth) acryloyloxyethylhexahydrophthalic acid [CH₂═C(CH₃)COOCH₂CH₂OCOC₆H₁₀COOH] and [CH₂═CHCOOCH₂CH₂OCOC₆H₁₀COOH].

Moreover, with respect to monomer (A) containing at least one member selected from a sulfonic acid group and a sulfonate group, examples thereof include compounds that contain at least one member selected from a sulfonic acid group and a sulfonate group and that has a double bond between carbon atoms, such as:

vinylsulfonate, styrenesulfonate, (meth)allylsulfonate, (meth)allyloxybenzenesulfonate, 2-acrylamide-2-methylpropanesulfonate, 2-sulfoxyethyl(meth)acrylate, sodium salts of these and ammonium salts of these.

Moreover, with respect to a monomer (A) containing at least one kind of a phosphoric acid group and a phosphate group, examples thereof include

a compound having at least one kind of phosphoric acid group and a phosphate group with a double bond between carbon atoms, such as 2-(meth)acroyloxyethyl acid phosphate.

These monomers (A) may be used alone or in combination thereof

Furthermore, “(B) a monomer having a cationic group and a double bond between carbon atoms (hereinafter, referred to as “monomer (B)”)” refers to a monomer which supplies a cationic group to a “polymer containing polyalkylene oxide groups” through a polymerization reaction (addition polymerization or radical polymerization).

“Cationic group” refers to the above-mentioned cationic group, which includes “a functional group having a positive charge (including a functional group that is electrically neutralized by a paired anion)” and “a functional group capable of forming a functional group having a positive charge by receiving a hydrogen ion in water”. Therefore, with respect to the cationic group, examples thereof include an amino group, a pyridyl group, an ammonium base, and a pyridylium base.

Moreover, “double bond between carbon atoms” refers to the above-mentioned double bond between carbon atoms.

Monomer (B) may have any of the combinations of the above-mentioned cationic groups and double bonds between carbon atoms, as long as it does not give any adverse effect on the properties of the resulting polymer containing polyalkylene oxide groups, and it is not intended to be limited by the number of cationic groups contained therein and the number of double bonds between carbon atoms.

Monomer (B) preferably contains at least one member selected from the group consisting of an amino group and an ammonium base as the cationic group.

Examples of monomer (B) include:

compounds having a primary amino group and a double bond between carbon atoms, such as allylamine;

compounds having a tertiary amino group and a double bond between carbon atoms, such as —(N,N-dialkylamino)alkyl(meth)acrylamide, for example, 3-(N,N-dimethylamino)propyl(meth)acrylamide, and —(N, N-dialkylamino)alkyl(meth)acrylate, for example, 2-(N,N-dimethylamino)ethyl(meth)acrylate and 2-(N,N-diethylamino)ethyl(meth)acrylate;

compounds having a quaternary ammonium base in which the tertiary amino group of-(N,N-dialkylamino)alkyl(meth)acrylamide, such as 3-(N,N-dimethylamino)propyl(meth)acrylamide, is further alkylated (more specifically, examples thereof include: N,N,N-trimethyl-N-(3-methacrylamidepropyl)ammonium chloride [CH₂═C(CH₃)CONH—CH₂CH₂CH₂—N⁺(CH₃)₃Cl⁻], N-(3-methacrylamide) propyl-N,N-dimethyl-N-(2-hydroxypropyl)ammonium acetate [CH₂═C(CH₃)CONH—CH₂CH₂CH₂—N⁺(CH₃)₂—CH₂CH(OH)CH₃CH₃COO⁻], and N-(3-methacrylamide)propyl-N,N,N-trimethylammonium sulfate [CH₂═C(CH₃)CONH—CH₂CH₂CH₂—N⁺(CH₃) ₃CH₃SO₄⁻]);

compounds having a quaternary ammonium base in which the tertiary amino group of-(N, N-dialkylamino)alkyl(meth)acrylate, such as 2-(N,N-dimethylamino)ethyl(meth)acrylate and 2-(N,N-diethylamino)ethyl(meth)acrylate, is further alkylated (more specifically, examples thereof include: N,N,N-trimethyl-N-(2-methacryloxyethyl)ammonium chloride [CH₂═C(CH₃)COO—CH₂CH₂—N⁺(CH₃)₃Cl⁻]N-(2-methacryloyloxy)ethyl-N,N,N-trimethylammonium methyl sulfate [CH₂═C(CH₃)COO—CH₂CH₂—N⁺(CH₃)₃CH₃SO₄⁻], N-(2-methacryloyloxy)ethyl-N,N-dimethyl-N-ethylammonium ethyl sulfate [CH₂═C(CH₃)COO—CH₂CH₂—N⁺(CH₃)₂C₂H₅C₂H₅SO₄⁻], and N-(2-methacryloyloxy)ethyl-N,N,N-trimethylammonium p-toluene sulfonate [CH₂═C(CH₃)COO—CH₂CH₂—N⁺(CH₃)₃CH₃C₆H₄SO₃⁻]. Examples thereof further include: N-(3-methacryloyloxy-2-hydroxy)ethyl-N,N,N-trimethylammonium acetate [CH₂═C(CH₃)COO—CH₂CH(OH)CH₂—N⁺(CH₃)₃CH₃COO⁻]); and

compounds having a quaternary ammonium base and a double bond between carbon atoms, such as a compound of N,N-dialkyl-N,N-diallylammonium halide, for example, N,N-dimethyl-N,N-diallylammonium chloride, etc.

With respect to monomer (B), a compound having a primary amino group and a double bond between carbon atoms, a monomer having a tertiary amino group and a double bond between carbon atoms and a monomer having a quaternary ammonium base and a double bond between carbon atoms are preferably used.

Moreover, with respect to monomer (B), in particular, a monomer having a tertiary amino group and a double bond between carbon atoms and a monomer having a quaternary ammonium base and a double bond between carbon atoms are more preferably used.

These monomers (B) may be used alone or in combination thereof.

Furthermore, a monomer containing a polyalkylene group (hereinafter, referred to as “monomer (C)”), which is (C) a monomer having a polyalkylene oxide group and a double bond between carbon atoms, the polyalkylene oxide group being represented by formula (1):

—(R¹—O)ₙ—R² (I)

[in formula (I),

R¹ represents an ethylene group or a propylene group,

R² represents an alkyl group having carbon atoms of 1 to 20, which may contain hydrogen or a substitute group, and

n is an integer in the range of 1 to 300],

is allowed to provide a polymer containing polyalkylene oxide groups by a polymerization reaction (addition polymerization or radical polymerization), the polyalkylene oxide group being represented by formula (1).

“The polyalkylene oxide group” represented by formula (I) refers to the above-mentioned polyalkylene oxide group, and R¹, R² and n refer to the above-mentioned R¹, R² and n.

Moreover, “double bond between carbon atoms” refers to the above-mentioned double bond between carbon atoms.

Therefore, monomer (C) may have any of the combinations of the above-mentioned polyalkylene oxide groups and double bonds between carbon atoms, as long as it does not give any adverse effect on the properties of “the polymer containing polyalkylene oxide groups”, and it is not intended to be limited by the number of polyalkylene oxide groups contained therein and the number of double bonds between carbon atoms.

Examples of such a monomer (C) include:

polyalkylene oxide(meth)acrylic acid esters, such as polyethylene oxide(meth)acrylic acid ester, methoxypolyethylene oxide(meth)acrylic acid ester, polypropylene oxide(meth)acrylic acid ester, and methoxypolypropylene oxide(meth)acrylic acid ester;

polyalkylene oxide monoallyl ethers, such as polyethylene oxide monoallyl ether, methoxypolyethylene oxide monoallyl ether, polypropylene oxide monoallyl ether, and methoxypolypropylene oxide monoallyl ether;

maleic acid polyalkylene oxide diesters, such as maleic acid monomethoxypolyethylene oxide diester, and maleic acid monomethoxypolypropylene oxide diester; and

itaconic acid polyalkylene oxide diesters, such as itaconic acid monomethoxypolyethylene oxide diester and itaconic acid monomethoxypolypropylene oxide diester.

With respect to monomer (C), polyalkylene oxide(meth)acrylic acid esters and polyalkylene oxide monoallyl ethers are preferably used.

These monomers (C) may be used alone or in combination thereof.

“The polymer containing polyalkylene oxide groups” in accordance with the present invention is obtained by polymerizing a monomer mixture containing monomer (A), monomer (B) and monomer (C), as well as (D) a monomer which contains a polyalkylene oxide group and a double bond between carbon atoms and also has at least one member selected from the group consisting of an anionic group and a cationic group (hereinafter, also referred to as “monomer (D)”).

With respect to a monomer containing a polyalkylene oxide group, a double bond between carbon atoms and an anionic group, which is one kind of monomer (D), examples thereof include:

maleic acid polyalkylene oxide half esters, such as maleic acid monomethoxypolyethylene oxide half ester and maleic acid monomethoxypolypropylene oxide half ester; and

itaconic acid polyalkylene oxide half esters, such as itaconic acid monomethoxypolyethylene oxide half ester and itaconic acid monomethoxypolypropylene oxide half ester.

These monomers (D) may be used alone, or in combination thereof.

“The polymer containing polyalkylene oxide groups” in accordance with the present invention is obtained by polymerizing a monomer mixture which contains monomer (A), monomer (B) and monomer (C), as well as a monomer (D), if necessary, and also contains (E) a monomer having an anionic group, a cationic group and a double bond between carbon atoms (hereinafter, also referred to as “monomer (E)”). Monomer (E) may be used as all or a part of monomer (A) and monomer (B).

A compound which is a so-called betaine having a double bond between carbon atoms may be used as monomer (E).

With respect to monomer (E),

examples thereof include compounds having a cationic group (for example, a quaternary ammonium base or pyridinium base), an anionic group (for example, carboxylate group or sulfonate group) and a double bond between carbon atoms, such as N,N-dimethyl-N-(3-methacrylamide)propylglycine betaine [CH₂═C(CH₃)CONH—CH₂CH₂CH₂—N⁺(CH₃)₂—CH₂—COO⁻] and N,N-dimethyl-N-(2-methacryloyloxy)ethylglycine betaine [CH₂═C(CH₃)COO—CH₂CH₂—N⁺(CH₃)₂—CH₂—COO⁻], N-(3-sulfopropyl)-N-methacryloxyethyl-N,N-dimethylammonium betaine [CH₂═C(CH₃)COO—CH₂CH₂—N⁺(CH₃)₂—CH₂CH₂CH₂—SO₃⁻], N-(3-sulfopropyl)-N-methacrylamidepropyl-N,N-dimethylammonium betaine [CH₂═C(CH₃)CONH—CH₂CH₂CH₂—N⁺(CH₃)₂—CH₂CH₂CH₂—SO₃^{-], and} 1-(3-sulfopropyl)-2-vinylpyridinium betaine [CH₂═CH—C₅H₄N⁺—CH₂CH₂CH₂—SO₃⁻], etc.

These monomers (E) may be used alone, or in combination thereof.

“The polymer containing polyalkylene oxide groups” in accordance with the present invention is obtained by polymerizing a monomer mixture which contains monomer (A), monomer (B) and monomer (C), as well as a monomer (D), if necessary, and also contains monomer (E), if necessary, as well as (F) another monomer having a double bond between carbon atoms (hereinafter, also referred to as “monomer (F)”).

“Monomer (F)” is a monomer having a double bond between carbon atoms, which is neither monomer (A), monomer (B), monomer (C), monomer (D), nor monomer (E), and which is copolymerizable (addition polymerization or radical polymerization) with monomer (A), monomer (B) and monomer (C); and is not particularly limited as long as it does not give any adverse effects on the polymerization reaction and the properties of the polymer having polyalkylene oxide groups.

Examples of these monomers (F) include:

(F1) (meth)acrylic acid alkyl esters, such as methyl(meth)acrylate, ethyl(meth)acrylate, propyl(meth)acrylate, butyl(meth)acrylate, hexyl(meth)acrylate, octyl(meth)acrylate, 2-ethylhexyl(meth)acrylate, decyl(meth)acrylate and dodecyl(meth)acrylate;

(F2) (meth)acrylic acid hydroxyalkyl esters, such as hydroxyethyl(meth)acrylate and hydroxypropyl(meth)acrylate;

(F3) (meth)acrylic acid amides, such as (meth)acrylic acid amide and (meth)acrylic acid methylol amide;

(F4) (meth)acrylic acid esters having an epoxy group such as glycidyl(meth)acrylate;

(F5) styrene and styrene derivatives such as styrene and vinyltoluene;

(F6) alkenes such as ethylene and propylene, and dienes such as butadiene and isoprene;

(F7) carboxylic acid vinyl ester compounds such as vinyl acetate and vinyl propionate;

(F8) chlorinated vinyl compounds such as vinyl chloride and vinylene chloride; and

(F9) monomers containing a cyano group such as acrylonitrile and having an ethylene-based double bond.

These monomers (F) may be used alone, or in combination thereof.

The ratio of the number of anionic groups and the number of cationic groups (anionic groups/cationic groups) contained in a monomer mixture used for obtaining “a polymer containing polyalkylene oxide groups”, (contained in its monomer (A), monomer (B), and monomer (D) added, if necessary, and monomer (E) added, if necessary) is preferably set in the range of 30/70 to 99.5/0.5, more preferably, 50/50 to 99.5/0.5, and most preferably, 80/20 to 99/1.

Therefore, the amounts of monomer (A), monomer (B), monomer (D) added, if necessary, and monomer (E) further added, if necessary, are preferably set so as to satisfy such a ratio of the number of anionic groups and the number of cationic groups. Moreover, in the case when none of monomer (D) and monomer (E) are used, the amounts of monomer (A) and monomer (B) are preferably set so as to satisfy the ratio of the number of anionic groups and cationic groups.

In general, the ratio of the number of anionic groups and the number of cationic groups (anionic groups/cationic groups) contained in a monomer mixture is virtually the same as the ratio of the number of anionic groups and the number of cationic groups (anionic groups/cationic groups) that are contained in “a polymer containing polyalkylene oxide groups.”

The ratio of the number of polyalkylene oxide groups and the sum of the numbers of cationic groups and anionic groups (that is, the number of polyalkylene oxide groups/(the number of cationic groups+the number of anionic groups)) contained in a monomer mixture used for obtaining “a polymer containing polyalkylene oxide groups”, (contained in its monomer (A), monomer (B), monomer (C) and monomer (D) added, if necessary, and monomer (E) further added, if necessary) is preferably set in the range of 10/90 to 50/50, more preferably, 15/85 to 45/55, and most preferably, 20/80 to 40/60.

Therefore, the amounts of monomer (A), monomer (B), monomer (C), monomer (D) added, if necessary, and monomer (E) further added, if necessary, are preferably set so as to satisfy such a ratio of the number of polyalkylene oxide groups and the sum of the numbers of cationic groups and anionic groups. Moreover, in the case when none of monomer (D) and monomer (E) are used, the amounts of monomer (A), monomer (B) and monomer (C) are preferably set so as to satisfy the ratio of the number of alkylene oxide groups and the sum of the numbers of cationic groups and anionic groups.

In general, the ratio of the number of aforementioned polyalkylene oxide groups and the sum of the numbers of cationic groups and anionic groups (the number of polyalkylene oxide groups/(the number of cationic groups+the number of anionic groups)), which are contained in a monomer mixture is virtually the same as the ratio of the number of polyalkylene oxide groups and the sum of the numbers of anionic groups and the number of cationic groups (the number of polyalkylene oxide groups/(the number of cationic groups+the number of anionic groups)), which are contained in “a polymer containing polyalkylene oxide groups.”

Moreover, it is preferable for monomer (C) to be contained in the monomer mixture (100% by weight) used for obtaining a polymer containing polyalkylene oxide groups in the range of 50 to 95% by weight, more preferably, 70 to 92% by weight, and most preferably, 80 to 90% by weight.

Furthermore, in the monomer mixture used for obtaining “a polymer containing polyalkylene oxide groups”, it is preferable to set the amount of monomer (F) in the range of 0 to 20 parts by weight when it is added to the sum of the above-mentioned monomer (A), monomer (B), monomer (C), monomer (D) added, if necessary, and monomer (E) further added, if necessary, that is, ((A)+(B)+(C)+(D)+(E)) of 100 parts by weight, more preferably, 0 to 15 parts by weight, and more preferably, 0 to 10 parts by weight.

“The polymer containing polyalkylene oxide groups” is prepared by polymerizing a monomer mixture which contains monomer (A), monomer (B) and monomer (C), as well as monomer (D), if necessary, and also contains monomer (E), if necessary, as well as monomer (F), if necessary, so that a dispersant composition for inorganic substances in accordance with the present invention is manufactured.

In the preparation of the dispersant composition for inorganic substances of the present invention, the monomer mixture is preferably polymerized by using a polymerization initiator. Here, the polymerization is carried out by using a known method such as a solution polymerization, an emulsion polymerization and a suspension polymerization, in a solvent.

In the preparation of the dispersant composition for inorganic substances in the present invention, the order in which the monomers are polymerized is not particularly limited. Therefore, all the monomers may be polymerized at one time, or to one part of the monomers that has been preliminarily heated, the other monomers may be added so as to carry out the polymerization.

Moreover, the polymerization initiator is preferably added thereto in a separated manner from the monomers or the mixture of the monomers.

With respect to the conditions of the polymerization, such as the reaction temperature and reaction time of the polymerization, the solvent and concentrations of respective monomers in the solvent, the kinds and concentrations of the polymerization initiator, chain transfer agent and emulsifier, and the stirring rate, a person skilled in the art could easily select appropriately depending on the property, form, etc. of the dispersant composition for inorganic substances to be obtained.

The polymerization in the solvent may be carried out either in a batch process or in a continuous process, and with respect to the solvent, examples thereof include: so-called water, such as pure water, distilled water and ion exchange water, lower alcohols, such as methyl alcohol, ethyl alcohol and isopropyl alcohol, aromatic hydrocarbons, such as benzene, toluene and xylene, aliphatic hydrocarbons, such as cyclohexane and n-hexane, esters such as ethylacetate, and carbonyl compounds such as acetone and methylethylketone.

Taking into consideration the solubility of each monomer to the solvent, the solubility of the resulting polymer containing polyalkylene oxide groups and the state at the time of use of the dispersant composition for inorganic substances made from the polymer, the above-mentioned aqueous solvents are preferably used as the solvent.

Moreover, with respect to “the polymerization initiator”, it is preferable to use such a compound as to initiate a polymerization reaction in the monomer mixture even when it is slightly added thereto, and to be used in an aqueous solvent and an organic compound.

Examples thereof include peroxides, such as ammonium persulfate, sodium persulfate, potassium persulfate, hydrogen peroxide and t-butylhydroperoxide and t-butylperoxybenzoate, and azo compounds, such as 2,2-azobisisobutyronitrile, 2,2′-azobis(2-amidinopropane)dihydrochloride and 2,2-azobis(2,4-dimethyl)valeronitrile.

In particular, ammonium persulfate, sodium persulfate, potassium persulfate and hydrogen peroxide are preferably used.

Upon polymerization, accelerators, such as sodium hydrogensulfite and Mohr's salt, may be used in combination with the polymerization initiator.

Moreover, with respect to “the chain transfer agent”, it is preferable to use such a compound as to adjust the molecular weight of the polymer even when it is slightly added thereto, and to be used in an aqueous solvent and an organic solvent. Examples of such “chain transfer agents” include mercaptoethanol, thioglycerol, thioglycolic acids, thioglycolic acid octyls, mercaptomethylpropionate, and n-dodecylmercaptan. In particular, mercaptoethanol, thioglycerol and thioglycolic acid are preferably used.

Moreover, “the emulsifier” refers to a surfactant which is used for forming an emulsion between the aqueous solvent and each monomer, and which is preferably a surfactant giving no adverse effects on the polymerization reaction. The emulsifier may be a mixture selected from the group consisting of compounds having a sulfonic acid group, a sulfonate group or a sulfate ester group and mixtures thereof, and may also be a normal surfactant.

With respect to “the surfactant”, examples thereof include anionic surfactants, such as soap, alkylsulfonate, and polyoxyethylene alkyl sulfate; and nonionic surfactants such as polyoxyalkyl aryl ether and oxyethyleneoxypropylene block copolymers.

In particular, a polymerizable emulsifier is preferably used as the emulsifier.

Here, “the polymerizable emulsifier” is a compound which has a polymerizable functional group, and is allowed to function as an emulsifier capable of forming an emulsion between the aqueous solvent and the monomer mixture. With respect to the polymerizable emulsifier, preferable examples thereof include: an ethylene-based unsaturated monomer selected from the group consisting of a sulfonic acid group, a sulfonate group, a sulfate ester group or an ethyleneoxy group and mixtures of these. Further, the sulfonic acid group or the sulfonate group of the polymerizable emulsifier may be in the form of salt, and with respect to paired cations of the sulfonic acid group or the sulfonate group, ammonium ions and alkali metal ions are preferably used, and in particular, ammonium ions, potassium ions and sodium ions are more preferably used.

Examples of materials containing such a polymerizable emulsifier include: Eleminol JS-2 (trade name) made by Sanyo Kasei (K.K.), Eleminol RS-30 (trade name) made by Sanyo Kasei (K.K.), Aquaron RN-20 (trade name) made by Daiichi Kogyo Seiyaku (K.K.), Aquaron HS-10 (trade name) made by Daiichi Kogyo Seiyaku (K.K.), etc.

The “polymer containing polyalkylene oxide groups”, obtained as described above, as it is, may be used as the dispersant composition for inorganic substances of the present invention; however, a neutralized matter obtained by neutralizing the polymer with an alkali substance or an acid substance may be preferably used. Moreover, a mixture between a neutralized matter and an unneutralized matter may be used.

Taking into consideration the safety at the time of handling, it is more preferable to use neutralized matters.

The neutralization of the polymer containing polyalkylene oxide groups may be carried out by using a conventional generally-used method; for example, a method is proposed in which, upon completion of above polymerization reaction, while the resulting mixture is being stirred and cooled at room temperature, an aqueous solution of an alkali substance, such as sodium hydroxide, potassium hydroxide, ammonia or calcium hydroxide, or an acidic substance, such as hydrochloric acid, acetic acid, sulfuric acid or citric acid is added thereto The completion of the neutralizing reaction can be confirmed by the fact that the pH of the reaction mixture has reached 6 to 8. For example, it is preferably judged by using universal testing paper, a pH meter, etc.

Moreover, in the present invention, the resulting polymer containing polyalkylene oxide groups or the neutralized matter thereof after the reaction, may be used as the dispersant composition for inorganic substances of the present invention in the same form as that after the reaction, without being separated from the solvent, the polymerization initiator, etc.

Moreover, in order to adjust the properties of the dispersant composition for inorganic substances, if necessary, to the mixture as it is, of the polymer containing polyalkylene oxide groups or the neutralized matter thereof after the polymerization, a known mixing agent of a dispersant composition for inorganic substances, for example, a conventional dispersant composition for inorganic substances, a thickener, etc. may be appropriately added. In particular, in the case when the dispersant composition for inorganic substances of the present invention is used as a dispersant composition for inorganic substances for forming a hydraulic composition, an antifoamer, an air-directing agent, a wetting dispersant, a waterproofing agent, a strength-improver, a cure-delaying agent, a cure-accelerator, etc. may be added.

Moreover, after the polymer containing polyalkylene oxide groups or the neutralized matter thereof after the polymerization reaction has been separated from the polymerization reaction solvent and the polymerization initiator and after this has been dissolved or dispersed in an appropriate solvent, various appropriate additive agents for known dispersant compositions for inorganic substances may be added thereto, if necessary, so as to form a dispersant composition for inorganic substances.

In the present invention, the rate of addition of these additive agents to the polymer containing polyalkylene oxide groups or the neutralized matter thereof is preferably set in the range of 0.01 to 50% by weight in its solid form without containing the solvent, more preferably, 0.01 to 5% by weight, and most preferably, 0.05 to 1% by weight.

The dispersant composition for inorganic substances of the present invention, used in the presence of an aqueous solvent, is preferably applied to inorganic pigments, such as titanium dioxide, calcium carbonate and clay, as well as to hydraulic materials, such as calcined calcium sulfate and cement.

Since the dispersant composition for inorganic substances of the present invention is prepared in the presence of a solvent, it forms a mixed state with the solvent when it is prepared, and in this state, the dispersant composition is preferably in a virtually dissolved state. However, the dispersant composition of the present invention may assume a solid form (for example, powder) or a liquid form which is obtained by eliminating the solvent by using an appropriate method (for example, evaporation, etc.).

Moreover, the dispersant composition of the present invention includes a material in which such a solid or liquid is mixed with, or preferably, dissolved in an aqueous solvent to which the dispersant composition is applied or in other aqueous solvents.

### EXAMPLES

The following description will discuss the present invention by means of Examples and Comparative Examples; however, each of these Examples only shows one preferred mode of the present invention, and the present invention is not intended to be limited by these.

(1) Monomers (A) to (C), which are used to prepare the dispersant composition for inorganic substances of the present invention, are shown as follows:

(A1) to (A4) are monomers (A), each having an anionic group and a double bond between carbon atoms:

(A1) is acrylic acid;

(A2) is maleic anhydride;

(A3) is sodium p-styrenesulfonate;

(A4) is mono [2-(methacryloyloxy]ethyl)phosphate [CH₂═CH(CH₃)COOCH₂CH₂OPO₃H₂].

(B1) to (B4) are monomers (B), each having a cationic group and a double bond between carbon atoms.

(B1) is 2-(dimethylamino)ethyl methacrylate [CH₂═CH(CH₃)COOCH₂CH₂N(CH₃)₂];

(B2) is N,N,N-trimethyl-N-(2-methacryloxyethyl)ammonium chloride [CH₂═CH(CH₃)COOCH₂CH₂N+(CH₃)₃Cl^{-];}

(B3) is N-[3-(dimethylamino)propyl]methacrylamide [CH₂═CH(CH₃)CONHCH₂CH₂CH₂N(CH₃)₂]; and

(B4) is dimethyldiallylammonium chloride [(CH₂═CHCH₂)₂N⁺(CH₃)₂Cl^{-].}

(C1) to (C3) are monomers (C), each having a polyalkylene oxide group and a double bond between carbon atoms:

(C1) is monomethoxypolyethylene oxide monomethacrylate [CH₂═C(CH₃)COO(CH₂CH₂O)ₙCH₃(n=30)];

(C2) is monomethoxypolyethylene oxide monomethacrylate [CH₂═C(CH₃)COO(CH₂CH₂O)ₙCH₃(n=23)];

(C3) is polyethylene oxide monoallylether [CH₂═CHCH₂O(CH₂CH₂O)ₙH(n=16)].

(1) Preparation of a Dispersant Composition for Inorganic Substances

Preparation of a Dispersant Composition of Example 1

To a 1-liter separable flask having a reflux condenser, an oil bath, a stirrer, two dropping funnels and a thermometer were loaded 12 g of maleic anhydride (A2), 13.6 g of as aqueous solution of sodium hydroxide of 50% by weight and 320 g of distilled water, and this was closed and heated while being stirred, and the mixture was maintained at 80 degrees C. Meanwhile, an aqueous solution was prepared in which to 70 g of distilled water were dissolved 20 g of acrylic acid (A1), 8 g of 2-(dimethylamino)ethylmethacrylate (B1), 160 g of monomethoxypolyethylene oxide monomethacrylate [CH₂═C(CH₃) COO(CH₂CH₂O)ₙCH₃(n=30)](C1) and 1.6 g of 2-mercaptoethanol, and an aqueous solution was also prepared in which to 200 g of distilled water was dissolved 2.4 g of sodium persulfate. These two aqueous solutions were simultaneously dropped into the above-mentioned mixture that contained the maleic anhydride (A2) and that was maintained at 80 degrees C. The aqueous solution containing (A1), (B1) and (C1) was dropped in three hours, and the aqueous solution of sodium persulfate was dropped in three and a half hours. After the aqueous solution of sodium persulfate had been dropped, this was further stirred for one hour at 80 degrees C. so that the polymerization reaction was completed. The ratios of the respective monomers are listed in Table 1 in parts by weight.

After the reaction mixture had been cooled to normal temperature, to this was added 30 ml of an aqueous solution of sodium hydroxide of 50% by weight with the pH thereof being observed by using a pH meter so that the pH was adjusted to 6 to 8; thus, a dispersant composition for inorganic substances of Example 1, which contained a neutralized matter of a target polymer (hereinafter, also referred to as “polymer”) having polyalkylene oxide groups. The weight average molecular weight (converted based upon polyethylene oxide) of the neutralized matter of the polymer was examined by using a water-system GPC (column: GMPW_{XL} (brand name) made by Toso (K.K.)), and a value 41,000 was obtained. Moreover, the concentration of the solid components in the dispersant composition for inorganic substances in Example 1 was 25.9% by weight.

Preparation of a Dispersant Composition of Example 2

To a 1-liter separable flask having a reflux condenser, an oil bath, a stirrer, two dropping funnels and a thermometer were loaded 4 g of maleic anhydride (A2), 4.5 g of an aqueous solution of sodium hydroxide of 50% by weight and 320 g of distilled water, and this was closed and heated while being stirred, and the mixture was maintained at 80 degrees C. Meanwhile, an aqueous solution was prepared in which to 70 g of distilled water were dissolved 16 g of acrylic acid (A1), 8 g of N,N,N-trimethyl-N-(2methacryloxyethyl)ammonium chloride [CH₂═CH(CH₃)COOCH₂CH₂N⁺(CH₃)₃Cl⁻](B2), 172 g of monomethoxypolyethylene oxide monomethacrylate [CH₂═C(CH₃) COO(CH₂CH₂O)ₙCH₃(n=23)](C2) and 3 g of 2-mercaptoethanol, and an aqueous solution was also prepared in which to 200 g of distilled water was dissolved 3.0 g of sodium persulfate. These two aqueous solutions were simultaneously dropped into the above-mentioned mixture that contained the maleic anhydride (A2) and that was maintained at 80 degrees C. The aqueous solution containing (A1), (B2) and (C2) was dropped in three hours, and the aqueous solution of sodium persulfate was dropped in three and a half hours. Thereafter, the dispersant composition of Example 2 was obtained by using the same method as described in Example 1. The ratios of the respective monomers used in preparing the dispersant composition of Example 2, the molecular weight of the neutralized matter of the polymer contained in the dispersant composition and the concentration of the solid components in the dispersant composition are listed in Table 1.

Preparation of a Dispersant Composition of Example 3

To a 1-liter separable flask having a reflux condenser, an oil bath, a stirrer, two dropping funnels and a thermometer was loaded 320 g of distilled water, and this was closed and heated while being stirred, and maintained at 80 degrees C. Meanwhile, an aqueous solution was prepared in which to 70 g of distilled water were dissolved 16 g of acrylic acid (A), 4.4 g of sodium p-styrenesulfonate (A3), 8 g of N,N,N-trimethyl-N-(2-methacryloxyethyl)ammonium chloride (B2), 172 g of monomethoxypolyethylene oxide monomethacrylate (C2), and 3.0 g of 2-mercaptoethanol, and an aqueous solution was also prepared in which to 200 g of distilled water was dissolved 3.0 g of sodium persulfate. These two aqueous solutions were simultaneously dropped into the above-mentioned distilled water in the flask that was maintained at 80 degrees C. The aqueous solution containing (A1), (A3), (B2) and (C2) was dropped in three hours, and the aqueous solution of sodium persulfate was dropped in three and a half hours. Thereafter, the dispersant composition of Example 3 was obtained by using the same method as described in Example 1. The ratios of the respective monomers used in preparing the dispersant composition of Example 3, the molecular weight of the neutralized matter of the polymer contained in the dispersant composition and the concentration of the solid components in the dispersant composition are listed in Table 1.

Preparation of a Dispersant Composition of Example 4

The same method as described in the preparation of the dispersant composition of Example 3 was carried out except that, instead of 4.4 g of sodium p-styrenesulfonate (A3), 4.0 g of mono (2-(methacryloyloxy)ethyl) phosphate [CH₂═CH(CH₃) COOCH₂CH₂OPO₃H₂] (A4) was used; thus, a dispersant composition of Example 4 was obtained. The ratios of the respective monomers used in preparing the dispersant composition of Example 4, the molecular weight of the neutralized matter of the polymer contained in the dispersant composition and the concentration of the solid components in the dispersant composition are listed in Table 1.

Preparation of a Dispersant Composition of Example 5

The same method as described in the preparation of the dispersant composition of Example 3 was carried out except that, instead of 16 g of acrylic acid (A1), 20 g of (A1) was used, and that no sodium p-styrenesulfonate (A3) was used; thus, a dispersant composition of Example 5 was obtained. The ratios of the respective monomers used in preparing the dispersant composition of Example 5, the molecular weight of the neutralized matter of the polymer contained in the dispersant composition and the concentration of the solid components in the dispersant composition are listed in Table 1.

Preparation of a Dispersant Composition of Example 6

The same method as described in the preparation of the dispersant composition of Example 3 was carried out except that, instead of 16 g of acrylic acid (A1) and 4.4 g of sodium p-styrenesulfonate (A3), 20 g of (A1) was used, and that, instead of 172 g of monomethoxypolyethylene oxide monomethacrylate (C2), 160 g of (C2) and 12 g of polyethylene oxide monoallyl ether [CH₂═CHCH₂O(CH₂CH₂O)ₙH(n=16)](C3) was used; thus, a dispersant composition of Example 6 was obtained. The ratios of the respective monomers used in preparing the dispersant composition of Example 6, the molecular weight of the neutralized matter of the polymer contained in the dispersant composition and the concentration of the solid components in the dispersant composition are listed in Table 1.

Preparation of a Dispersant Composition of Example 7

The same method as described in the preparation of the dispersant composition of Example 3 was carried out except that, instead of 16 g of acrylic acid (A1) and 4.4 g of sodium p-styrenesulfonate, 20 g of (A1) was used, and that, instead of 8 g of N,N,N-trimethyl-N-(2-methacryloxyethyl)ammonium chloride (B2), 8 g of N-[3-(dimethylamino) propyl]methacrylamide [CH₂═CH(CH₃)CONHCH₂CH₂CH₂N(CH₃)₂] (B3) was used; thus, a dispersant composition of Example 7 was obtained. The ratios of the respective monomers used in preparing the dispersant composition of Example 7, the molecular weight of the neutralized matter of the polymer contained in the dispersant composition and the concentration of the solid components in the dispersant composition are listed in Table 1.

Preparation of a Dispersant Composition of Example 8

The same method as described in the preparation of the dispersant composition of Example 1 was carried out except that, instead of 8 g of 2-(dimethylamino)ethyl methacrylate (B1), 12.3 g of dimethyldiallylammonium chloride [(CH₂═CHCH₂)₂ N⁺(CH₃)₂Cl⁻] (B4) was used, and that, instead of 160 g of monomethoxypolyethylene oxide monomethacrylate (C₁), 160 g of monomethoxypolyethylene oxide monomethacrylate (C2) was used; thus, a dispersant composition of Example 8 was obtained. The ratios of the respective monomers used in preparing the dispersant composition of Example 8, the molecular weight of the neutralized matter of the polymer contained in the dispersant composition and the concentration of the solid components in the dispersant composition are listed in Table 1.

TABLE 1

| | Example | | | | | | | |
|---|---|---|---|---|---|---|---|---|
| | 1 | 2 | 3 | 4 | 5 | 6 | 7 | 8 |
| Monomer^{a)} | | | | | | | | |
| (A) (A1) | 10 | 8 | 8 | 8 | 10 | 10 | 10 | 10 |
| (A2) | 6 | 2 | | | | | | 6 |
| (A3) | | | 2 | | | | | |
| (A4) | | | | 2 | | | | |
| (B) (B1) | 4 | | | | | | | |
| (B2) | | 4 | 4 | 4 | 4 | 4 | | |
| (B3) | | | | | | | 4 | |
| (B4) | | | | | | | | 4 |
| (C) (C1) | 80 | | | | | | | |
| (C2) | | 86 | 86 | 86 | 86 | 80 | 86 | 80 |
| (C3) | | | | | | 6 | | |
| Molecular | 41000 | 22000 | 28000 | 42000 | 29000 | 26000 | 31000 | 20000 |
| weight^{b)} | | | | | | | | |
| Concentra-tion | 25.9 | 27.7 | 26.2 | 28.0 | 25.8 | 27.0 | 25.9 | 26.3 |
| ^{c)} | | | | | | | | |

^{a)}Unit: parts by weight
^{b)}Weight-average molecular weight of a neutralized matter of the polymer
^{c)}Concentration: % by weight of solid components in the dispersant composition

Preparation of a Dispersant Composition of Comparative Example 1

The same method and processes as described in the preparation of the dispersant composition of Example 3 were carried out except that, instead of 16 g of acrylic acid (A1) and 4.4 g of sodium p-styrene sulfonic acid (A3), 28 g of (A1) was used, and except that, instead of 8 g of N,N,N-trimethyl-N-(2-methacryloxyethyl)ammonium chloride (B2) and 172 g of monomethoxypolyethylene oxide monomethacrylate (C2), 172 g of monomethoxypolyethylene oxide monomethacrylate (C1) was used; thus, a dispersant composition of Comparative Example 1 was obtained. The ratios of the respective monomers used in preparing the dispersant composition of Comparative Example 1, the molecular weight of the neutralized matter of the polymer contained in the dispersant composition and the concentration of the solid components in the dispersant composition are listed in Table 2.

Preparation of a dispersant composition of Comparative Example 2

The same method and processes as described in the preparation of the dispersant composition of Example 3 were carried out except that, instead of 8 g of N,N,N-trimethyl-N-(2-methacryloxyethyl)ammonium chloride (B2), 28 g of 2-(dimethylamino)ethyl methacrylate (B1) was used, without using 16 g of acrylic acid (A1) and 4.4 g of sodium p-styrene sulfonic acid (A3); thus, a dispersant composition of Comparative Example 2 was obtained. The ratios of the respective monomers used in preparing the dispersant composition of Comparative Example 2, the molecular weight of the neutralized matter of the polymer contained in the dispersant composition and the concentration of the solid components in the dispersant composition are listed in Table 2.

Preparation of a Dispersant Composition of Comparative Example 3

The same method and processes as described in the preparation of the dispersant composition of Example 3 were carried out except that, instead of 8 g of N,N,N-trimethyl-N-(2-methacryloxyethyl)ammonium chloride (B2), 28 g of (B2) was used, and except that, instead of 172 g of monomethoxypolyethylene oxide monomethacrylate (C2), 160 g of (C2) was used without using 16 g of acrylic acid (A1) and 4.4 g of sodium p-styrene sulfonic acid (A3); thus, a dispersant composition of Comparative Example 3 was obtained. The ratios of the respective monomers used in preparing the dispersant composition of Comparative Example 3, the molecular weight of the neutralized matter of the polymer contained in the dispersant composition and the concentration of the solid components in the dispersant composition are listed in Table 2.

TABLE 2

| | Comparative Example | | | |
|---|---|---|---|---|
| | 1 | 2 | 3 | 4 |
| Monomer^{a)} | | | | |
| (A) (A1) | 14 | | | |
| (A2) | | | | |
| (A3) | | | | |
| (A4) | | | | |
| (B) (B1) | | 14 | | |
| (B2) | | | 20 | |
| (B3) | | | | |
| (B4) | | | | |
| (C) (C1) | 86 | | | |
| (C2) | | 86 | 80 | |
| (C3) | | | | |
| Molecular | 11000 | 27000 | 31000 | 2600 |
| weight^{b)} | | | | |
| Concentra-tion | 26.3 | 25.4 | 26.6 | |
| ^{c)} | | | | |

^{a)}Unit: parts by weight
^{b)}Weight-average molecular weight of a neutralized matter of the polymer
^{c)}Concentration: % by weight of solid components in the dispersant composition

Dispersant Composition of Comparative Example 4

With respect to the dispersant composition of Comparative Example 4, sodium polyacrylate having a weight average molecular weight of 2600 (ALCOSPERSE149 (trade name) made by ALCO Co., Ltd.) was used as it was. The concentration of solid components of the dispersant composition of Comparative Example 4 are shown in Table 2.

(3) Evaluation of the Dispersing Property of the Dispersant Composition to Inorganic Substances

Dispersant compositions of Example 4 and Comparative Example 4 were used as the dispersant composition.

The following materials were used as the inorganic substances:

1. Titanium dioxide (rutile type)(made by Kanto Kagaku K.K.)

2. Heavy calcium carbonate (made by Takehara Kagaku Kogyo K.K.)

3. Kaolin clay (made by Tsuchiya Kaolin K.K.)

4. Calcined calcium sulfate (made by Wako Pure Chemical Industries, Ltd.)

5. Cement (normal Portland cement)(made by Mitsubishi material K.K.)

Each of the above-mentioned five kinds of powders (0.4 g) was added to each of the dispersant compositions of Example 4 and Comparative Example 4 so that its amount of solid components was set to 0.2 g. Moreover, to this was added distilled water so that the total amount thereof was set to 20 ml; thus, each of the mixtures for evaluation on the dispersing property was prepared. After having been sufficiently stirred, the mixture for evaluation was transferred to a measuring cylinder of 20 ml.

When this mixture for evaluation is left standing still and the suspended inorganic substance is allowed to precipitate, the mixture for evaluation is separated to a lower layer having the suspended inorganic substance and an upper layer of supernatant in which no suspension is observed after precipitation of the suspended inorganic substance. The border line between the lower layer and the upper layer shifts downward in the mixture for evaluation as the precipitation of the inorganic substance precedes; therefore, the precipitation of the inorganic substance in the mixture was measured by visually observing the position of the border line on the measuring cylinder. Since the faster the precipitation, the worse the dispersing property, the greater the figure on the measuring cylinder thus read (the closer to 20), the dispersing property of the inorganic substance is better. The results are shown in Table 3.

TABLE 3

| | Time elapsed^{b)} | | | | | |
|---|---|---|---|---|---|---|
| | 0 | 0.25 | 1 | 3 | 24 | 48 |
| Titanium oxide^{a)} | | | | | | |
| No addition | 20.0 | 9.5 | 0.5 | | | |
| Example 4 | 20.0 | 20.0 | 20.0 | 20.0 | 19.5 | 19.5 |
| Comparative example 4 | 20.0 | 19.5 | 19.5 | 19.5 | 16.0 | 11.5 |
| Calcium carbonate^{a)} | | | | | | |
| No addition | 20.0 | 19.5 | 13.5 | 3.5 | | |
| Example 4 | 20.0 | 20.0 | 18.0 | 12.0 | | |
| Comparative example 4 | 20.0 | 20.0 | 15.5 | 5.0 | | |
| Kaolin clay^{a)} | | | | | | |
| No addition | 20.0 | 10.5 | 4.0 | 0.5 | | |
| Example 4 | 20.0 | 16.0 | 8.5 | 5.0 | | |
| Comparative example 4 | 20.0 | 15.5 | 7.5 | 3.0 | | |
| Calcined calcium sulfate^{a)} | | | | | | |
| No addition | 20.0 | 0.5 | 0.5 | 0.5 | | |
| Example 4 | 20.0 | 14.0 | 8.5 | 0.5 | | |
| Comparative example 4 | 20.0 | 0.5 | 0.5 | 0.5 | | |
| Cement^{a)} | | | | | | |
| No addition | 20.0 | 0.5 | 0.5 | 0.5 | | |
| Example 4 | 20.0 | 11.0 | 7.5 | 2.5 | | |
| Comparative example 4 | 20.0 | 10.5 | 4.5 | 0.5 | | |

^{a)}“No addition” refers to a case in which no additive agent compositions were used, “Example 4” refers to a case in which the dispersant composition of Example 4 was added, and “Comparative Example 4” refers to a case in which the dispersant composition of Comparative Example 4 was added. In each of “the No addition”, “Example 4” and “Comparative Example 4” cases, the unit was ml.
^{b)}The unit of time elapsed was hour (hr).

The addition of the dispersant composition of Example 4 allowed the inorganic substance to quickly disperse in water; therefore, it is confirmed that the dispersant composition of Example 4 has a superior dispersing property. Moreover, in the case when the dispersant composition of Comparative Example 4 was added, in any of the inorganic substances, the inorganic substance precipitated more quickly as compared with the case in which the dispersant composition of Example 4 was added. Therefore, it is confirmed that the dispersant composition of Example 4 is superior in the dispersing stability.

(4) Evaluation of the Dispersant Composition as a Cement Dispersant

Evaluation of the Dispersant Composition of Example 1 as a Cement Dispersant

(a) Preparation of Cement Mortar

In order to evaluate the dispersant composition of the present invention as a cement dispersant, cement mortar was prepared in the same method as described in JIS R 5201. In other words, 4.6 g and 5.8 g of the dispersant composition of Example 1 were mixed with 300 g of water, respectively, and each of these was added to a mixture preliminarily prepared by kneading 600 g of normal Portland cement that was commercially available with 1800 g of sand (specific gravity: 2.62, fineness modulus: 2.60), and this was stirred at a low speed for one minute, and then stirred at a high speed for two minutes, using a mortar mixer to obtain cement mortar. In these cases, the rate of addition (solid components of the dispersant composition/cement 100) of the solid components of the dispersant compositions were 0.20% by weight and 0.25% by weight respectively.

(b) Evaluation of the Cement Dispersing Property

With respect to the cement mortar thus prepared, a flow test was carried out by using the same method as described in JIS R 5201 so as to evaluate the dispersing property of cement on the dispersant composition of Example 1. In other words, the kneaded cement mortar was injected into a flow cone (upper-end inner diameter: 7 cm, lower-end inner diameter: 10 cm, height: 6 cm) on a horizontal flow table, and then the flow cone was raised upward; thus, the spread of the cement mortar was measured. Here, after the flow cone had been drawn out, the flow table was not allowed to drop, and the spread of the mortar, as it was, was measured. The spread of the cement mortar is referred to as a flow value, and the greater the flow value, the better the dispersing property. The results of evaluation are shown in Table 4.

(c) Evaluation of Cement Setting Time

Moreover, evaluation on cement setting time was evaluated after the addition of the cement to the dispersant composition of Example 1. In other words, the cement mortar, prepared by using the same method as in the case of evaluation on the dispersing property, was loaded in an insulated container, and changes in the heat generation of the cement mortar were measured in association with the elapsed time so that the time required for reaching the peak top of the heat generation (hereinafter, referred to as “cement setting time” in which the unit was hour (hr)) was obtained. In the case when the rate of addition of the dispersant composition of Example 1 was 0.20% by weight, the time was 7.7 hours. The shorter the cement setting time, the better since this means that the addition of the dispersant composition only gives less adverse effects on the setting of the cement mortar. The results of evaluation are shown in Table 4.

Evaluation of the Dispersant Compositions of Examples 2 to 8 and Comparative Examples 1 to 3 as Cement Dispersants

The same method and processes as described in Example 1 were carried out except that the dispersant compositions of Examples 2 to 8 and Comparative Examples 1 to 3 were used so as to set the rates of addition of the neutralized matters of the respective polymers at 0.20% by weight and 0.25% by weight, respectively; thus, the dispersing property and the cement setting time of the dispersant compositions of Examples 2 to 8 and Comparative Examples of 1 to 3 were evaluated. The results of the evaluation are shown in Tables 4 to 6.

TABLE 4

| | Example | | | | | | | |
|---|---|---|---|---|---|---|---|---|
| | 1 | | 2 | | 3 | | 4 | |
| Rate of addition | 0.20 | 0.25 | 0.20 | 0.25 | 0.20 | 0.25 | 0.20 | 0.25 |
| ^{a)} | | | | | | | | |
| Dispersing | 169 | 215 | 173 | 225 | 178 | 254 | 187 | 234 |
| property^{b)} | | | | | | | | |
| Setting time^{c)} | 7.7 | 8.1 | 8.0 | 8.7 | 7.5 | 8.2 | 8.6 | 9.0 |

^{a)}Rate of addition of the solid components of the dispersant composition, given as % by weight indicated by (solid components of the dispersant composition/cement 100).
^{b)}Flow value, in which the unit is mm.
^{c)}The unit is hour (hr).

TABLE 5

| | Example | | | | | | | |
|---|---|---|---|---|---|---|---|---|
| | 5 | | 6 | | 7 | | 8 | |
| Rate of addition | 0.20 | 0.25 | 0.20 | 0.25 | 0.20 | 0.25 | 0.20 | 0.25 |
| ^{a)} | | | | | | | | |
| Dispersing | 177 | 250 | 163 | 214 | 179 | 223 | 159 | 220 |
| property^{b)} | | | | | | | | |
| Setting time^{c)} | 7.9 | 8.3 | 8.3 | 9.0 | 7.6 | 8.2 | 8.1 | 8.9 |

^{a)}Rate of addition of the solid components of the dispersant composition, given as % by weight indicated by (solid components of the dispersant composition/cement 100).
^{b)}Flow value, in which the unit is mm.
^{c)}The unit is hour (hr).

TABLE 6

| | Comparative Example | | | | | |
|---|---|---|---|---|---|---|
| | 1 | | 2 | | 3 | |
| Rate of | 0.20 | 0.25 | 0.20 | 0.25 | 0.20 | 0.25 |
| addition^{a)} | | | | | | |
| Dispersing | 112 | 138 | 113 | 140 | 109 | 135 |
| property^{b)} | | | | | | |
| Setting time^{c)} | 9.5 | 10.0 | 9.1 | 10.4 | 10.9 | 12.4 |

^{a)}Rate of addition of the solid components of the dispersant composition, given as % by weight indicated by (solid components of the dispersant composition/cement 100).
^{b)}Flow value, in which the unit is mm.
^{c)}The unit is hour (hr).

Any one of Examples 1 to 8 is a dispersant composition consisting of a polymer having polyalkylene oxide groups, anionic groups and cationic groups at the same time. On the other hand, any one of Comparative Examples 1 to 3 is a dispersant composition consisting of a polymer having either anionic groups or cationic groups although it has polyalkylene oxide groups. The results of the experiments show that any of the dispersant compositions of Comparative Examples are inferior in either of the dispersing property and the cement setting time.

The dispersant composition for inorganic substances, used in the presence of an aqueous solvent, contains a polymer containing polyalkylene oxide groups, the polyalkylene oxide group being represented by formula (1):

—(R¹—O)ₙ-R² (I)

[in formula (1),

R¹ represents an ethylene group or a propylene group,

R² represents an alkyl group having carbon atoms of 1 to 20, which may contain hydrogen or a substitute group, and

n is an integer in the range of 1 to 300],

wherein the polymer, which contains polyalkylene oxide groups, also contains anionic group and cationic groups so that at least one of the dispersing property and dispersing stability of the inorganic substance to water can be improved.

Moreover, the anionic group of the polymer containing polyalkylene oxide groups is at least one kind selected from the group consisting of carboxyl groups, sulfonic acid groups, phosphoric acid group, carboxylate group, sulfonate group and phosphate group; therefore, it is possible to improve the dispersing property of the inorganic substance to water.

Furthermore, the cationic group of the polymer containing polyalkylene oxide groups is at least one kind selected from the group consisting of an amino group and an ammonium base; therefore, it is possible to improve the dispersing property of the inorganic substance to water.

Here, the polymer containing polyalkylene oxide groups has its ratio of the number of anionic groups and the number of cationic groups (number of anionic groups/number of cationic groups) set in the range of 30/70 to 99.5/0.5, it is possible to further improve the dispersing stability of the inorganic substance to water.

The polymer containing polyalkylene oxide groups is obtained by polymerizing a monomer mixture consisting of:

(A) a monomer having an anionic group and a double bond between carbon atoms;

(B) a monomer having a cationic group and a double bond between carbon atoms; and

(C) a monomer having polyalkylene oxide group and a double bond between carbon atoms, wherein the polyalkylene oxide group is represented by formula (I):

—(R¹—O)ₙ-R² (I)

[in formula (I),

R¹ represents an ethylene group or a propylene group,

R² represents an alkyl group having carbon atoms of 1 to 20, which may contain hydrogen or a substitute group, and

n is an integer in the range of 1 to 300]. Therefore, it is possible to further improve the dispersing stability of the inorganic substance to water.

The application of the dispersant composition of the present invention makes it possible to improve, in particular, the dispersing property and dispersing stability of an inorganic pigment and a hydraulic material to water.

What is claimed is:

1. A dispersant composition for inorganic substances, which is used in the presence of an aqueous solvent, and contains a polymer containing polyalkylene oxide groups, the polyalkylene oxide group being represented by formula (I):
—(R¹—O)ₙ-R² (I)
[in formula (I),
R¹ represents an ethylene group or a propylene group,
R² represents an alkyl group having carbon atoms of 1 to 20, which may contain hydrogen or a substitute group, and
n is an integer in the range of 1 to 300],
wherein said having the polyalkylene oxide groups further contains anionic groups and cationic groups.

2. The dispersant composition according to claim 1, wherein said anionic group is at least one member selected from the group consisting of a carboxyl group, a sulfonic acid group, a phosphoric acid group, a carboxylate group, a sulfonate group and a phosphate group.

3. The dispersant composition according to claim 1 or 2, wherein said cationic group is at least one member selected from the group consisting of an amino group and an ammonium base.

4. The dispersant composition according to any one of claims 1 to 3, wherein a ratio of the number of anionic groups and the number of cationic groups (number of anionic groups/number of cationic groups) is set in a range of 30/70 to 99.5/0.5.

5. The dispersant composition according to any one of claims 1 to 4, wherein said polymer containing polyalkylene oxide groups is obtained by polymerizing a monomer mixture consisting of:
(A) a monomer having an anionic group and a double bond between carbon atoms;
(B) a monomer having a cationic group and a double bond between carbon atoms; and
(C) a monomer having polyalkylene oxide group and a double bond between carbon atoms,
said polyalkylene oxide group being represented by formula (I):
—(R¹—O)ₙ-R² (I)
[in formula (I),
R¹ represents an ethylene group or a propylene group,
R² represents an alkyl group having carbon atoms of 1 to 20, which may contain hydrogen or a substitute group, and
n is an integer in the range of 1 to 300].

6. The dispersant composition according to claim 5, wherein said monomer (A) contains at least one member selected from the group consisting of a carboxyl group, a sulfonic acid group, a phosphoric acid group, a carboxylate group, a sulfonate group and a phosphate group.

7. The dispersant composition according to claim 5 or 6, wherein said monomer (B) contains at least one member selected from the group consisting of an amino group and an ammonium base.

8. The dispersant composition according to any one of claims 5 to 7, wherein said monomer (C) contains at least one member selected from the group consisting of polyalkylene oxide(meth)acrylic acid ester and polyalkylene oxide monoallyl ether.

9. The dispersant composition according to any one of claims 1 to 8, wherein said inorganic substance is an inorganic pigment or a hydraulic material.

10. The dispersant composition according to any one of claims 1 to 9, which further contains an aqueous solvent.
